(19) United States
(12) Patent Application Publication
(10) Pub. No.: US 2024/0052227 A1
(43) Pub. Date: Feb. 15, 2024

(54) WATER-BASED POLYMER NETWORK FOR TRANSPIRANT COOLING APPLICATIONS

(71) Applicant: Raytheon Company, Waltham, MA (US)

(72) Inventors: Justin B. Alms, Coventry, CT (US); John A. Sharon, West Hartford, CT (US); Stephen P. Zeppieri, Glastonbury, CT (US)

(21) Appl. No.: 17/819,513

(22) Filed: Aug. 12, 2022

(51) Int. Cl. C09K 5/16; C08F 20/06; B64C 1/40

(52) U.S. Cl. CPC C09K 5/16; C08F 20/06; B64C 1/40

(57) ABSTRACT

A method includes obtaining thermal energy from a structure to be cooled, where the structure includes micro-channels. The method also includes providing the thermal energy to a water-based polymer network, where the water-based polymer network includes a gel formed using a polymer and water. The method further includes generating one or more gases by heating the water-based polymer network, where generating the one or more gases includes releasing the water in the water-based polymer network to produce steam. In addition, the method includes passing the one or more gases through the micro-channels to remove at least some of the thermal energy from the structure.

### GOVERNMENT RIGHTS

This invention was made with government support under contract number FA8650-20-C-7001 awarded by the United States Department of Defense. The government has certain rights in the invention.

### TECHNICAL FIELD

This disclosure relates generally to cooling systems. More specifically, this disclosure relates to a water-based polymer network for transpirant cooling applications.

### BACKGROUND

Certain types of flight vehicles can travel through the atmosphere at very high rates of speed. As a result, portions of these flight vehicles can experience extreme temperatures due to friction with the air. Without some sort of thermal management, these extreme temperatures can damage or destroy components of the flight vehicles, which can inhibit or prevent the flight vehicles from being used for their intended purposes.

### SUMMARY

This disclosure provides a water-based polymer network for transpirant cooling applications.

In a first embodiment, a method includes obtaining thermal energy from a structure to be cooled, where the structure includes micro-channels. The method also includes providing the thermal energy to a water-based polymer network, where the water-based polymer network includes a gel formed using a polymer and water. The method further includes generating one or more gases by heating the water-based polymer network, where generating the one or more gases includes releasing the water in the water-based polymer network to produce steam. In addition, the method includes passing the one or more gases through the micro-channels to remove at least some of the thermal energy from the structure.

In a second embodiment, an apparatus includes a structure to be cooled, where the structure includes micro-channels. The apparatus also includes a water-based polymer network configured to receive thermal energy from the structure. The water-based polymer network includes a gel formed using a polymer and water. The water-based polymer network is configured when heated to generate one or more gases, where the one or more gases include the water in the water-based polymer network released into steam. The micro-channels are configured to allow passage of the one or more gases in order to remove at least some of the thermal energy from the structure.

In a third embodiment, a flight vehicle includes a body having a leading edge, where the leading edge includes an outer structure having micro-channels. The flight vehicle also includes a water-based polymer network configured to receive thermal energy from the leading edge. The water-based polymer network includes a gel formed using a polymer and water. The water-based polymer network is configured when heated to generate one or more gases, where the one or more gases include the water in the water-based polymer network released into steam. The micro-channels are configured to allow passage of the one or more gases in order to remove at least some of the thermal energy from the leading edge.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example flight vehicle supporting a water-based polymer network in accordance with this disclosure;

FIGS. 2 and 3 illustrate an example nosecone of a flight vehicle supporting a water-based polymer network in accordance with this disclosure; and

FIG. 4 illustrates an example method for using a water-based polymer network for a transpirant cooling application in accordance with this disclosure.

### DETAILED DESCRIPTION

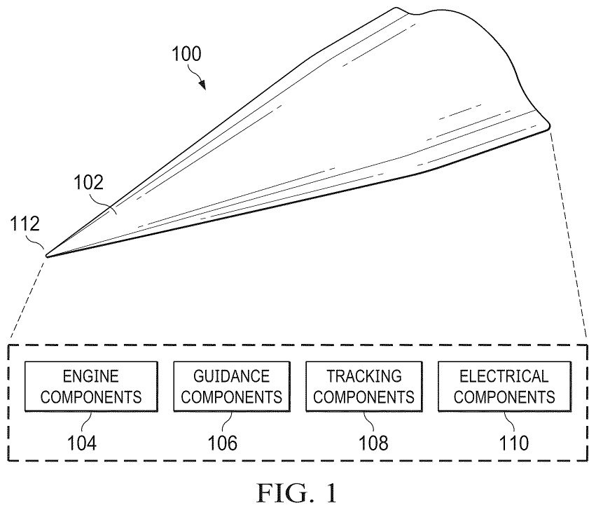

FIGS. 1 through 4, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, certain types of flight vehicles can travel through the atmosphere at very high rates of speed. As a result, portions of these flight vehicles can experience extreme temperatures due to friction with the air. Without some sort of thermal management, these extreme temperatures can damage or destroy components of the flight vehicles, which can inhibit or prevent the flight vehicles from being used for their intended purposes.

Some approaches for thermal management attempt to use exotic materials that can withstand elevated temperatures. For example, carbon-carbon composites may typically be prone to ablation, and exotic coatings may be used to help protect the carbon-carbon composites. However, these approaches are typically expensive and are not suitable for wide-spread fabrication. Other approaches for thermal management may use heat pumps and other active thermal management techniques, but these approaches generally consume power and take up significant space in flight vehicles or other systems.

This disclosure provides a water-based polymer network for transpirant cooling applications. As described in more detail below, a transpirant coolant is implemented in the form of a gel, where the gel includes a polymer (such as sodium polyacrylate) that has absorbed water. This effectively gelatinizes the water and uses osmosis to equilibrate sodium ions or other ions and form a polymer network. The polymer network in the gel does not break down upon heating to produce liquid water. Instead, water in the gel can be released to produce gases such as steam, which can be used during a transpiration cooling process. Moreover, the polymer itself may decompose into one or more gases (such as hydrogen gas) useful for transpiration purposes, and this decomposition can represent an endothermic process that further serves as a potential cooling process. Further, one or more other liquids or solids may optionally be mixed or dissolved into the water that is absorbed by the polymer network, and these one or more other liquids or solids may decompose into one or more useful gases for transpiration cooling purposes.

The gel represents a stable self-contained transpirant coolant, which can be used in flight vehicles or other applications to cool nosecones or other portions of the flight vehicles or other systems. Moreover, the gel can be easily injectable into nosecones or other portions of the flight vehicles or other systems, and the gel may be able to utilize all available space within the flight vehicles or other systems. Further, the gel can be relatively thick and act much like a solid material when significant external forces are not acting upon the gel, which means that the gel may function as a deformable solid in many cases. This allows the gel to remain in desired portions within the flight vehicles or other systems. In addition, in some cases, micro-channels or other pathways through which gases can exit a nosecone or other portion of a flight vehicle or other system can be selectively sealed, such as by using valves or one or more materials that can melt or liquify under elevated temperatures. This can help to reduce or prevent evaporation of the water from the gel until the gel is used for transpiration cooling.

Finally, this approach supports the use of water within the gel for cooling purposes. In many instances, using water as a coolant can be highly desirable since water has the ability to quickly remove lots of thermal energy. However, water has a tendency to leak through micro-channels or other passages, which can create problems in various devices (such as those including electronic circuitry). Also, even if the micro-channels or other passages are temporarily sealed, internal vapor pressure will typically eventually force all liquid water out of a given space, which can prevent the liquid water from vaporizing and removing the maximum amount of thermal energy from a flight vehicle or other system. The use of a gel as a transpirant coolant can help to reduce or eliminate the possibility of water leakage, thereby enabling effective cooling using water without the risks of water leakages. Internal pressure also typically cannot force the gel through the micro-channels, helping to maintain the gel (and its associated water) in suitable positions for cooling purposes.

A water-based polymer network can be used for transpirant cooling in any suitable devices or systems. In the following discussion, it is often assumed that the water-based polymer network is used in a flight vehicle, such as a rocket, missile, hypersonic vehicle, or other system that flies through the air. Also, in the following discussion, it is often assumed that the water-based polymer network is used in the nosecone of a flight vehicle. However, this example usage of the water-based polymer network is for illustration only. In general, the water-based polymer network may be used in any other suitable devices or systems in which transpirant cooling is needed or desired, and the water-based polymer network may be used in any suitable portion or portions of those devices or systems.

FIG. 1 illustrates an example flight vehicle 100 supporting a water-based polymer network in accordance with this disclosure. As shown in FIG. 1, the flight vehicle 100 generally represents an object that flies through, is launched through or into, or otherwise travels through a given space. The flight vehicle 100 can represent a vehicle that travels through an atmosphere and possibly in space. Example types of flight vehicles can include projectiles, rockets, missiles, drones, aircraft, satellites, and spacecraft. The flight vehicle 100 includes any suitable object configured to operate within a high-temperature environment.

In this particular example, the flight vehicle 100 represents a hypersonic vehicle, which typically refers to an object that can travel at a speed of at least Mach 5 (about 3,836 miles per hour or about 6,174 kilometers per hour). In such a hypersonic vehicle, friction caused by passage of the vehicle 100 through the atmosphere can generate large amounts of heat within the vehicle 100. Note that the form factor of the flight vehicle 100 shown in FIG. 1 is for illustration only. A number of hypersonic vehicle designs have been proposed, and this disclosure is not limited to any specific design for a hypersonic vehicle. Moreover, this disclosure is not limited to use with hypersonic vehicles. For example, any vehicle or other object in which heat can be generated through aerodynamic drag can be used here, or any object that otherwise generates adequate heat or is used in a high-temperature environment can be used here.

As can be seen in FIG. 1, the flight vehicle 100 includes a body 102, which generally surrounds other components of the flight vehicle 100. The body 102 can have any suitable size, shape, and dimensions. In a hypersonic flight vehicle, for example, the body 102 has a highly aerodynamic shape that enables the flight vehicle 100 to travel through the atmosphere at extremely high rates of speed. Of course, the design for the body 102 can vary widely based on the intended application. The body 102 can also be formed from any suitable material. Depending on the application and the environment in which the body 102 will be used, the body 102 can be formed from exotic materials that have extremely high temperature resistances. However, this is not required, and the body 102 can be formed from more conventional materials that can still withstand the expected temperatures for a given application. In addition, the body 102 can be formed in any suitable manner.

The flight vehicle 100 also includes various components, at least some of which can be partially or completely within the body 102 of the flight vehicle 100. For example, the flight vehicle 100 may include one or more engine components 104, which generally represent components used to generate thrust that propels the flight vehicle 100. The engine components 104 can include any suitable type of engine, such as a ramjet or scramjet. The flight vehicle 100 may also include one or more guidance components 106, which may be used to help guide the flight vehicle 100 during flight. The guidance components 106 can include any suitable type of location detection or guidance systems, such as Global Positioning System (GPS) receivers or other satellite-based or other location detection systems. The flight vehicle 100 may further include one or more tracking components 108, which may be used to track one or more objects or areas to be struck by the flight vehicle 100. The tracking components 108 can include any suitable type of object or other tracking systems, such as electro-optical (EO) tracking systems. In addition, the flight vehicle 100 may include one or more electrical components 110, which may be used to process data, control other components of the flight vehicle 100, or perform other functions in the flight vehicle 100. The electrical components 110 can include any suitable type of processing, control, or other electrical or electronic devices, such as microprocessors, microcontrollers, digital signal processors (DSPs), field programmable gate arrays (FPGAs), application-specific integrated circuits (ASICs), or discrete circuitry.

As described in more detail below, the flight vehicle 100 uses a water-based polymer network to support transpirant cooling of the flight vehicle 100 during use. The water-based polymer network may be used in any suitable portion or portions of the flight vehicle 100 where cooling may be needed or desired. In some cases, the water-based polymer network may be used in a nosecone 112 of the flight vehicle 100, such as along the leading edge of the nosecone 112. The nosecone 112 represents the tip of the flight vehicle 100 and may often represent the portion of the flight vehicle 100 that reaches the highest temperatures during flight. The nosecone 112 may be attached to or integrated with the body 102 of the flight vehicle 100. Note, however, that the water-based polymer network may be used in any other or additional portions of the flight vehicle 100, such as at or near inlets or control surfaces of the flight vehicle 100 or along the leading edge of at least one other structure or portion of the flight vehicle 100 (like a wing or fin).

Although FIG. 1 illustrates one example of a flight vehicle 100 supporting a water-based polymer network, various changes may be made to FIG. 1. For example, any other suitable devices or systems can include one or more instances of a water-based polymer network. Other example applications in which one or more instances of a water-based polymer network can be used include missiles, commercial or military rockets, or other commercial or military flight vehicles. Moreover, the water-based polymer network may be used in other environments and is not limited to use with flight vehicles.

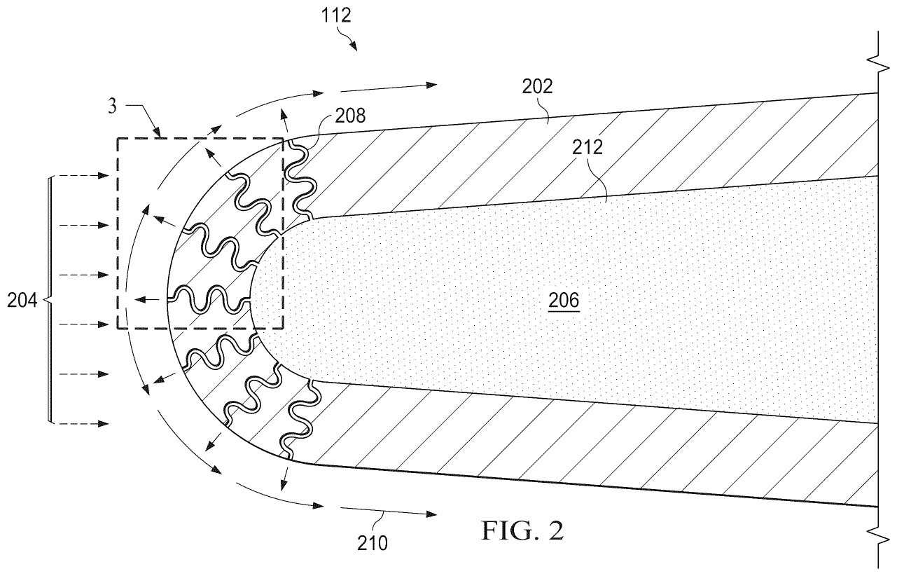

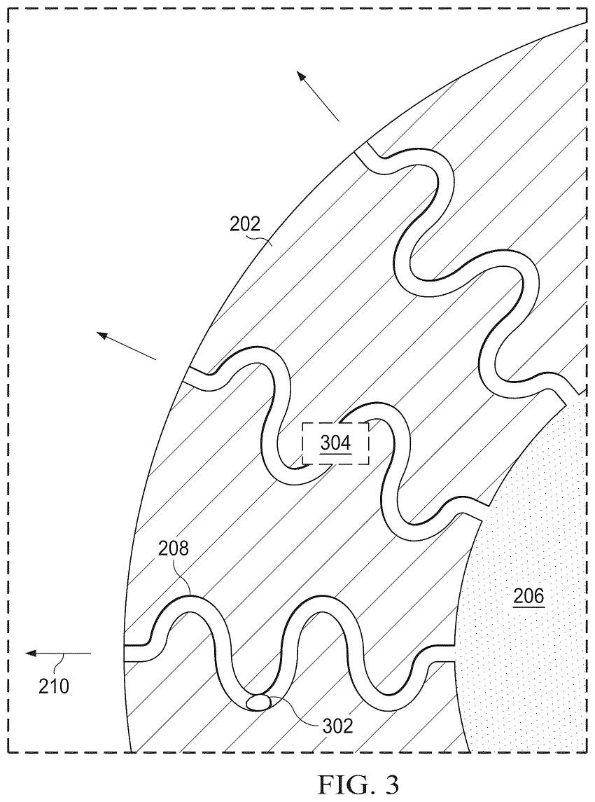

FIGS. 2 and 3 illustrate an example nosecone 112 of a flight vehicle supporting a water-based polymer network in accordance with this disclosure. For ease of explanation, the nosecone 112 is described as forming a part of the flight vehicle 100 shown in FIG. 1. However, the water-based polymer network may be used in any other suitable device or system, including other types of flight vehicles.

As shown in FIG. 2, the nosecone 112 is defined by an outer skin or other outer structure 202. The outer structure 202 generally represents the portion of the nosecone 112 that contacts air in the atmosphere during travel. Thus, the outer structure 202 can be subjected to substantial heat fluxes 204 during use of the flight vehicle 100, which can rapidly heat the nosecone 112 and potentially damage or destroy the nosecone 112 (without some form of thermal management). The outer structure 202 of the nosecone 112 may be formed from any suitable material(s), such as a refractory alloy. The outer structure 202 of the nosecone 112 may also be formed in any suitable manner. In addition, the outer structure 202 of the nosecone 112 may have any suitable size, shape, and dimensions.

A water-based polymer network 206 is positioned within the nosecone 112 and is capable of receiving thermal energy from the nosecone 112 or other source(s). The water-based polymer network 206 represents a gel formed using a polymer that has absorbed water, which gelatinizes the water. Any suitable polymer can be used here to form the gel, such as sodium polyacrylate. The water-based polymer network 206 can fill any desired space or spaces within the nosecone 112 or other structure. In this example, the water-based polymer network 206 is shown as substantially filling the space at the end of the nosecone 112. However, the water-based polymer network 206 may have any other suitable form within the nosecone 112. Although not shown here, the nosecone 112 may define one or more dedicated compartments or other spaces within the nosecone 112 for holding the water-based polymer network 206.

During use, thermal energy from the nosecone 112 can enter the water-based polymer network 206 and cause the water in the water-based polymer network 206 to be released into one or more gases, such as steam. Also, the polymer in the water-based polymer network 206 can undergo an endothermic reaction and generate one or more additional gases, such as hydrogen gas. Micro-channels 208 within the outer structure 202 allow these various gases 210 to escape through the outer structure 202 into an ambient environment. The creation of the gases 210 from the materials of the water-based polymer network 206 and the transport of the gases 210 through the micro-channels 208 into the ambient environment support a transpiration cooling process (and optionally a convective heat transfer cooling process) that can remove a significant amount of thermal energy from the nosecone 112. Each micro-channel 208 generally represents any suitable passageway through which gases can escape during a transpiration cooling process. Each micro-channel 208 may also be formed in any suitable manner. In addition, each micro-channel 208 may have any suitable size, shape, and dimensions and may follow any suitable path through the outer structure 202.

One or more additional materials 212 may optionally be used within the water-based polymer network 206. In some embodiments, for example, the one or more additional materials 212 may be mixed or dissolved into the water that is absorbed by the polymer network. These one or more additional materials 212 may similarly absorb thermal energy and produce one or more additional gases, which can escape as additional gases 210 through the outer structure 202 via the micro-channels 208. The one or more additional materials 212 may represent any suitable material or materials used to provide desired functionality in the water-based polymer network 206, such as one or more liquid materials or one or more solid materials. In some cases, for instance, the one or more additional materials 212 may include glycol, which can be added to the water in order to adjust the freezing point of the resulting mixture. The one or more additional materials 212 may also or alternatively include one or more salts, such as ammonia salt.

As shown in FIG. 3, an additional feature that may optionally be used with the water-based polymer network 206 involves selectively blocking the micro-channels 208. In the example shown in FIG. 3, for instance, a material 302 can be positioned within each of the micro-channels 208 in order to block that micro-channel 208. This can help to prevent water or other material(s) in the water-based polymer network 206 from evaporating or otherwise escaping from the water-based polymer network 206 through the micro-channels 208 until the flight vehicle 100 or other system is actually placed into use. As a particular example, the material 302 may be solid at lower temperatures but melt or otherwise liquify at elevated temperatures. As a result, once the water and possibly other material(s) in the water-based polymer network 206 begin to form one or more gases 210 during use of the flight vehicle 100 or other system, the internal pressure from the one or more gases 210 can eventually force the liquified material 302 out of the micro-channels 208. This may then allow the one or more gases 210 to escape from within the nosecone 112 and into the ambient environment. The material 302 includes any suitable material(s) configured to temporarily block micro-channels 208, such as paraffin wax or solder. Note that the use of liquifiable material 302 represents one example mechanism for selectively blocking the micro-channels 208, but other mechanisms may also be used. For instance, one or more valves 304 may be used to selectively open or block the micro-channels 208.

In some embodiments, the water-based polymer network 206 used in a flight vehicle 100 or other system may be replaceable. For example, the flight vehicle 100 or other system may be placed into operation, and the water-based polymer network 206 can be used to provide thermal management for the flight vehicle 100 or other system. If the flight vehicle 100 or other system is recovered, another water-based polymer network 206 can be injected or otherwise placed into the flight vehicle 100 or other system, thereby allowing the flight vehicle 100 or other system to be used again. In other embodiments, the nosecone 112 or other portion of the flight vehicle 100 or other system containing the water-based polymer network 206 may be replaceable. Thus, if the flight vehicle 100 or other system is recovered after use, another nosecone 112 or other portion of the flight vehicle 100 or other system containing another water-based polymer network 206 can be installed on the flight vehicle 100 or other system. Note, however, that this is not necessarily required, such as when certain flight vehicles or other systems are not reusable.

Although FIGS. 2 and 3 illustrate one example of a nosecone 112 of a flight vehicle 100 supporting a water-based polymer network 206, various changes may be made to FIGS. 2 and 3. For example, the relative sizes, shapes, and dimensions of the components shown in FIGS. 2 and 3 can vary as needed or desired. Also, the water-based polymer network 206 may be used in other environments and is not limited to use with nosecones 112 of flight vehicles specifically or to use with flight vehicles generally.

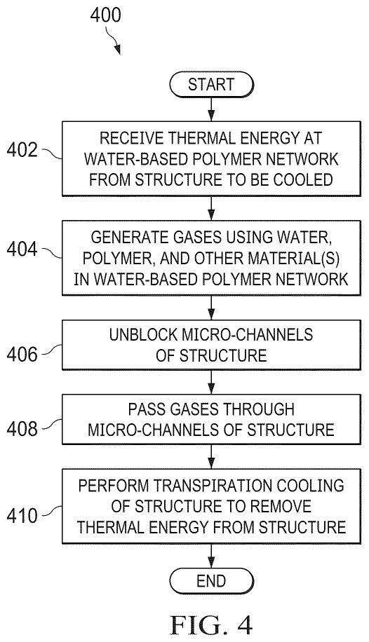

FIG. 4 illustrates an example method 400 for using a water-based polymer network for a transpirant cooling application in accordance with this disclosure. For ease of explanation, the method 400 is described as being performed within the flight vehicle 100 of FIG. 1 with the nosecone 112 of FIGS. 2 and 3. However, the method 400 may be performed using any other suitable device or system containing a water-based polymer network 206.

As shown in FIG. 4, thermal energy is received at a water-based polymer network from a structure to be cooled at step 402. This may include, for example, the water-based polymer network 206 receiving thermal energy from the nosecone 112 of the flight vehicle 100. The water-based polymer network 206 includes a gel formed by at least one polymer and absorbed water (and optionally one or more additional materials 212). One or more gases are generated using the water-based polymer network at step 404. This may include, for example, heating the water-based polymer network 206 using the thermal energy. This may also include the water of the water-based polymer network 206 releasing into steam or other gas(es) 210. This may further optionally include the polymer of the water-based polymer network 206 undergoing an endothermic reaction to produce hydrogen gas or other gas(es) 210. In addition, this may include one or more additional materials 212 in the water-based polymer network 206 (such as glycol or salt) producing one or more additional gases 210.

Micro-channels in the structure may optionally be unblocked at step 406. This may include, for example, material 302 that is blocking the micro-channels 208 melting or otherwise liquifying, such as due to the thermal energy in the nosecone 112 of the flight vehicle 100. This may also include internal pressure within the nosecone 112 of the flight vehicle 100 pushing the liquified material 302 out of the micro-channels 208. In other embodiments, this may include opening one or more valves 304 to unblock the micro-channels 208. The one or more gases are passed through the micro-channels and out of the structure at step 408. This may include, for example, the gases 210 escaping the nosecone 112 of the flight vehicle 100 through the micro-channels 208. This provides transpiration cooling of the structure in order to remove thermal energy from the structure at step 410.

Although FIG. 4 illustrates one example of a method 400 for using a water-based polymer network for a transpirant cooling application, various changes may be made to FIG. 4. For example, while shown as a series of steps, various steps in FIG. 4 may overlap, occur in parallel, occur in a different order, or occur any number of times.

The following describes example embodiments of this disclosure that implement or relate to water-based polymer networks for transpirant cooling applications. However, other embodiments may be used in accordance with the teachings of this disclosure.

In a first embodiment, a method includes obtaining thermal energy from a structure to be cooled, where the structure includes micro-channels. The method also includes providing the thermal energy to a water-based polymer network, where the water-based polymer network includes a gel formed using a polymer and water. The method further includes generating one or more gases by heating the water-based polymer network, where generating the one or more gases includes releasing the water in the water-based polymer network to produce steam. In addition, the method includes passing the one or more gases through the micro-channels to remove at least some of the thermal energy from the structure.

In a second embodiment, an apparatus includes a structure to be cooled, where the structure includes micro-channels. The apparatus also includes a water-based polymer network configured to receive thermal energy from the structure. The water-based polymer network includes a gel formed using a polymer and water. The water-based polymer network is configured when heated to generate one or more gases, where the one or more gases include the water in the water-based polymer network released into steam. The micro-channels are configured to allow passage of the one or more gases in order to remove at least some of the thermal energy from the structure.

In a third embodiment, a flight vehicle includes a body having a leading edge, where the leading edge includes an outer structure having micro-channels. The flight vehicle also includes a water-based polymer network configured to receive thermal energy from the leading edge. The water-based polymer network includes a gel formed using a polymer and water. The water-based polymer network is configured when heated to generate one or more gases, where the one or more gases include the water in the water-based polymer network released into steam. The micro-channels are configured to allow passage of the one or more gases in order to remove at least some of the thermal energy from the leading edge.

Any single one or any suitable combination of the following features may be used with the first, second, or third embodiment. The one or more gases may also include one or more additional gases based on an endothermic reaction involving the polymer in the water-based polymer network. The gel may further include at least one additional material mixed or dissolved in the water, and the one or more gases may further include one or more additional gases based on the at least one additional material. The at least one additional material may include at least one of: glycol and salt. The polymer may include sodium polyacrylate. The water-based polymer network may not break down and produce liquid water when heated by the thermal energy. The micro-channels may be unblocked to permit passage of the one or more gases through the micro-channels. A material blocking the micro-channels may be liquified and pushed out of the micro-channels to unblock the micro-channels. The micro-channels may be unblocked using one or more valves. The structure to be cooled may include a leading edge of a body of a flight vehicle. The body of the flight vehicle may include a nosecone, the leading edge may be associated with the nosecone, and the water-based polymer network may be positioned within the nosecone. The water-based polymer network in the nosecone may be replaceable, or the nosecone with the water-based polymer network may be replaceable.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining thermal energy from a structure to be cooled, the structure comprising micro-channels;
providing the thermal energy to a water-based polymer network, the water-based polymer network comprising a gel formed using a polymer and water;
generating one or more gases by heating the water-based polymer network, wherein generating the one or more gases comprises releasing the water in the water-based polymer network to produce steam; and
passing the one or more gases through the micro-channels to remove at least some of the thermal energy from the structure.

2. The method of claim 1, wherein generating the one or more gases further comprises producing one or more additional gases based on an endothermic reaction involving the polymer in the water-based polymer network.

3. The method of claim 1, wherein:
the gel further comprises at least one additional material mixed or dissolved in the water; and
generating the one or more gases further comprises producing one or more additional gases based on the at least one additional material.

4. The method of claim 3, wherein the at least one additional material comprises at least one of: glycol and salt.

5. The method of claim 1, wherein the polymer comprises sodium polyacrylate.

6. The method of claim 1, wherein the water-based polymer network does not break down and produce liquid water when heated by the thermal energy.

7. The method of claim 1, further comprising:
unblocking the micro-channels to permit passage of the one or more gases through the micro-channels.

8. The method of claim 7, wherein unblocking the micro-channels comprises one of:
liquifying a material blocking the micro-channels and pushing the liquified material out of the micro-channels; and
unblocking the micro-channels using one or more valves.

9. An apparatus comprising:
a structure to be cooled, the structure comprising micro-channels; and
a water-based polymer network configured to receive thermal energy from the structure, the water-based polymer network comprising a gel formed using a polymer and water, the water-based polymer network configured when heated to generate one or more gases, the one or more gases comprising the water in the water-based polymer network released into steam;
wherein the micro-channels are configured to allow passage of the one or more gases in order to remove at least some of the thermal energy from the structure.

10. The apparatus of claim 9, wherein the one or more gases further comprise one or more additional gases based on an endothermic reaction involving the polymer in the water-based polymer network.

11. The apparatus of claim 9, wherein:
the gel further comprises at least one additional material mixed or dissolved in the water; and
the one or more gases further comprise one or more additional gases based on the at least one additional material.

12. The apparatus of claim 11, wherein the at least one additional material comprises at least one of: glycol and salt.

13. The apparatus of claim 9, wherein the polymer comprises sodium polyacrylate.

14. The apparatus of claim 9, further comprising:
a material configured to block the micro-channels until liquified and pushed out of the micro-channels.

15. The apparatus of claim 9, further comprising:
one or more valves configured to block and unblock the micro-channels.

16. A flight vehicle comprising:
a body comprising a leading edge, the leading edge comprising an outer structure having micro-channels; and
a water-based polymer network configured to receive thermal energy from the leading edge, the water-based polymer network comprising a gel formed using a polymer and water, the water-based polymer network configured when heated to generate one or more gases, the one or more gases comprising the water in the water-based polymer network released into steam;
wherein the micro-channels are configured to allow passage of the one or more gases in order to remove at least some of the thermal energy from the leading edge.

17. The flight vehicle of claim 16, wherein at least one of:
the one or more gases further comprise one or more additional gases based on an endothermic reaction involving the polymer in the water-based polymer network; and
the gel further comprises at least one additional material mixed or dissolved in the water, and the one or more gases further comprise one or more additional gases based on the at least one additional material.

18. The flight vehicle of claim 16, wherein the polymer comprises sodium polyacrylate.

19. The flight vehicle of claim 16, further comprising one of:
a material configured to block the micro-channels until liquified and pushed out of the micro-channels; and
one or more valves configured to block and unblock the micro-channels.

20. The flight vehicle of claim 16, wherein:
the body comprises a nosecone;
the leading edge is associated with the nosecone; and
the water-based polymer network is positioned within the nosecone.

21. The flight vehicle of claim 20, wherein one of:
the water-based polymer network in the nosecone is replaceable; and
the nosecone with the water-based polymer network is replaceable.
